(19) United States
(12) Patent Application Publication
(10) Pub. No.: US 2026/0245233 A1
(43) Pub. Date: Aug. 20, 2026

(54) COORDINATE ESTIMATION SYSTEM, COORDINATE ESTIMATION DEVICE, AND COORDINATE ESTIMATION METHOD

(71) Applicant: NEC Corporation, Tokyo (JP)

(72) Inventors: Jiro ABE, Tokyo (JP); Kazumine OGURA, Tokyo (JP); Yuya MATSUMOTO, Tokyo (JP)

(73) Assignee: NEC Corporation, Tokyo (JP)

(21) Appl. No.: 19/164,301

(22) PCT Filed: Mar. 27, 2023
(86) PCT No.: PCT/JP2023/012228

§ 371 Date: Sep. 11, 2025

(51) Int. Cl. G06T 7/70; G06T 17/20; G06V 10/24

(52) U.S. Cl. CPC G06T 7/70; G06T 17/20; G06V 10/24; G06T 2207/30244; G06T 2210/21

(57) ABSTRACT

The alignment means aligns a near field image obtained by imaging a first imaging area of the object with at least one far field image obtained by imaging a second imaging area larger than the first imaging area of the object and including the first imaging area. The position attitude estimation means estimates an imaging position attitude including an imaging position and an imaging attitude in a point cloud coordinate system of at least one far field image on the basis of the point cloud of the object and the at least one far field image. The coordinate estimation means estimates, on the basis of the point cloud, the alignment result by the alignment means, and the imaging position attitude, a specific pixel coordinate in the point group coordinate system of at least one specific pixel, which is an arbitrary pixel of the near field image.

### TECHNICAL FIELD

The present invention relates to a coordinate estimation system, a coordinate estimation device, and a coordinate estimation method.

### BACKGROUND ART

PTL 1 discloses a technique for generating a superimposed image formed by superimposing an image captured using an infrared camera on a three-dimensional image showing a concrete structural part.

### CITATION LIST

### Patent Literature

PTL 1: JP 2020-154466 A

### SUMMARY OF INVENTION

### Technical Problem

Meanwhile, some of the existing infrastructures are already considerably degraded. In particular, in a case where abnormality such as cracking, floating, and peeling is found in a concrete structure at the time of inspection, it is an important problem to appropriately record and manage the position and size of the abnormality.

Therefore, the inventors of the present application have developed a digital twin of a concrete structure in order to achieve efficient maintenance and management of the concrete structure. Specifically, it is considered to superimpose a captured image of an abnormality found by an inspector at the time of inspection on a point cloud of a concrete structure. As a result, the position and the size of the abnormality can be efficiently grasped by referring to the point cloud on which the captured image is superimposed.

However, when the concrete structure is long such as a bridge, a dam, or a tunnel, the three-dimensional distance measurement of the concrete structure is performed at a distance of several tens of meters from the concrete structure. In view of the realistic resolution of the three-dimensional distance measurement, the resolution of the point cloud obtained by the three-dimensional distance measurement is at most one per square centimeter. That is, there is substantially only one point corresponding to a range of one square centimeter of the surface of the concrete structure.

On the other hand, when the inspector images an abnormality at the time of inspection, the imaging is performed several meters away from the abnormality. In view of the realistic resolution of the imaging, the resolution of the captured image obtained by imaging is about 2500 pixels per square centimeter. That is, there are approximately 2500 pixels corresponding to a range of one square centimeter of the surface of the concrete structure.

As described above, since there is a large resolution difference between the point cloud and the captured image, it is difficult to estimate where the captured image corresponds to in the point cloud.

An object of the present disclosure is to provide a technique for estimating a positional relationship between a point cloud and a captured image having greatly different resolutions.

### Solution to Problem

According to a first aspect of the present disclosure, a coordinate estimation system including an alignment means for aligning a close view image obtained by imaging a first imaging region of an object with at least one distant view image obtained by imaging a second imaging region that is larger than the first imaging region of the object and includes the first imaging region, a position/posture estimation means for estimating an imaging position/posture including an imaging position and an imaging posture in a point cloud coordinate system of an image capturing apparatus that has captured the at least one distant view image based on a point cloud of the object and the at least one distant view image, and a coordinate estimation means for estimating specific pixel coordinates in a point cloud coordinate system of at least one specific pixel that is an arbitrary pixel of the close view image based on the point cloud, an alignment result by the alignment means, and the imaging position/posture.

According to a second aspect of the present disclosure, a coordinate estimation device including an alignment means for aligning a close view image obtained by imaging a first imaging region of an object with at least one distant view image obtained by imaging a second imaging region that is larger than the first imaging region of the object and includes the first imaging region, a position/posture estimation means for estimating an imaging position/posture including an imaging position and an imaging posture in a point cloud coordinate system of an image capturing apparatus that has captured the at least one distant view image based on a point cloud of the object and the at least one distant view image, and a coordinate estimation means for estimating specific pixel coordinates in a point cloud coordinate system of at least one specific pixel that is an arbitrary pixel of the close view image based on the point cloud, an alignment result by the alignment means, and the imaging position/posture.

According to a third aspect of the present disclosure, a coordinate estimation method including alignment step in which a computer aligns a close view image obtained by imaging a first imaging region of an object with at least one distant view image obtained by imaging a second imaging region that is larger than the first imaging region of the object and includes the first imaging region, a position/posture estimation step in which the computer estimates an imaging position/posture including an imaging position and an imaging posture in a point cloud coordinate system of an image capturing apparatus that has captured the at least one distant view image based on a point cloud of the object and the at least one distant view image, and a coordinate estimation step in which the computer estimates specific pixel coordinates in a point cloud coordinate system of at least one specific pixel that is an arbitrary pixel of the close view image based on the point cloud, an alignment result by the alignment step, and the imaging position/posture.

### Advantageous Effects of Invention

According to the present disclosure, a positional relationship between a point cloud and a captured image having greatly different resolutions from each other can be estimated.

### BRIEF DESCRIPTION OF DRAWINGS

FIG. 1 is a functional block diagram of a coordinate estimation system. (Outline of Present Disclosure)

FIG. 2 is a functional block diagram of a coordinate estimation device. (First Example Embodiment)

FIG. 3 is a work flow in a preliminary preparation phase. (First Example Embodiment)

FIG. 4 is a photograph of a bridge. (First Example Embodiment)

FIG. 5 is a three-dimensional image of a bridge including a point cloud. (First Example Embodiment)

FIG. 6 is a diagram illustrating imaging regions of a close view image and a distant view image. (First Example Embodiment)

FIG. 7 is an example of a close view image. (First Example Embodiment)

FIG. 8 is an example of a distant view image. (First Example Embodiment)

FIG. 9 is a data structure diagram of an image storage unit. (First Example Embodiment)

FIG. 10 is an explanatory diagram of a homography matrix. (First Example Embodiment)

FIG. 11 is an operation explanatory diagram of a coordinate estimation unit. (First Example Embodiment)

FIG. 12 is an operation explanatory diagram of the coordinate estimation unit. (First Example Embodiment)

FIG. 13 is an example of a superimposed image. (First Example Embodiment)

FIG. 14 is an output example of the superimposed image. (First Example Embodiment)

FIG. 15 is a data structure diagram of a history DB. (First Example Embodiment)

FIG. 16 is a control flow of the coordinate estimation device. (First Example Embodiment)

FIG. 17 is an operation explanatory diagram of the coordinate estimation unit. (Second Example Embodiment)

FIG. 18 is an operation explanatory diagram of a coordinate estimation unit. (Third Example Embodiment)

FIG. 19 is a plan view illustrating imaging conditions of a close view image and a distant view image. (Fourth Example Embodiment)

FIG. 20 is a control flow of the coordinate estimation device. (Fourth Example Embodiment)

FIG. 21 is a control flow of the coordinate estimation device. (Fourth Example Embodiment)

FIG. 22 is a plan view illustrating a positional relationship between an imaging position, a bridge, and specific pixel coordinates. (Fifth Example Embodiment)

FIG. 23 is a diagram illustrating an angle for each extracted distant view image. (Fifth Example Embodiment)

FIG. 24 is a control flow of the coordinate estimation device. (Fifth Example Embodiment)

FIG. 25 is a control flow of the coordinate estimation device. (Fifth Example Embodiment)

### EXAMPLE EMBODIMENT

### Outline of Present Disclosure

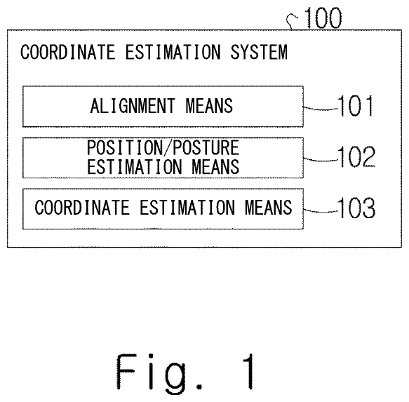

Hereinafter, an outline of the present disclosure will be described with reference to FIG. 1. As illustrated in FIG. 1, a coordinate estimation system 100 includes an alignment means 101, a position/posture estimation means 102, and a coordinate estimation means 103.

The alignment means 101 aligns a close view image obtained by imaging a first imaging region of the object with at least one distant view image obtained by imaging a second imaging region larger than the first imaging region of the object and including the first imaging region.

The position/posture estimation means 102 estimates an imaging position/posture including an imaging position and an imaging posture in a point cloud coordinate system of at least one distant view image based on a point cloud of an object and the at least one distant view image.

The coordinate estimation means 103 estimates specific pixel coordinates in the point cloud coordinate system of at least one specific pixel, that is an arbitrary pixel of the close view image, based on the point cloud, the alignment result by the alignment means, and the imaging position/posture.

According to the above configuration, the positional relationship between the point cloud and the close view image (captured image) having greatly different resolutions from each other can be estimated.

### First Example Embodiment

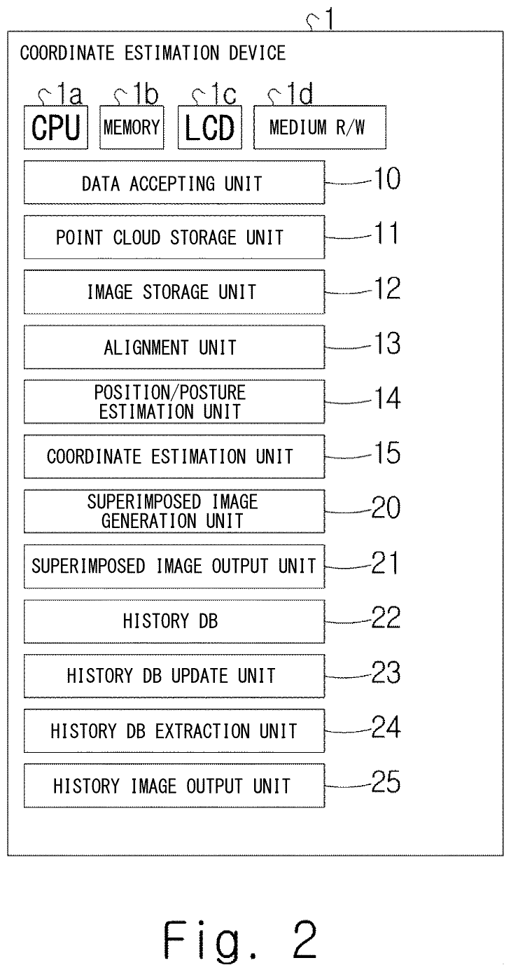

Next, a first example embodiment of the present disclosure will be described with reference to FIGS. 2 to 16.

FIG. 2 illustrates a functional block diagram of a coordinate estimation device 1. The coordinate estimation device 1 illustrated in FIG. 2 is used to achieve efficient maintenance and management of a concrete structure by superimposing an image of abnormality captured at the time of inspection of the concrete structure on a point cloud of the concrete structure such as, for example, a bridge, a dam, or a tunnel. The concrete structure is a specific example of an object to be maintained and managed. The abnormality in the concrete structure is typically cracking, lifting, or peeling. Hereinafter, a bridge as a concrete structure is assumed as an object to be maintained and managed.

### Preliminary Preparation Flow

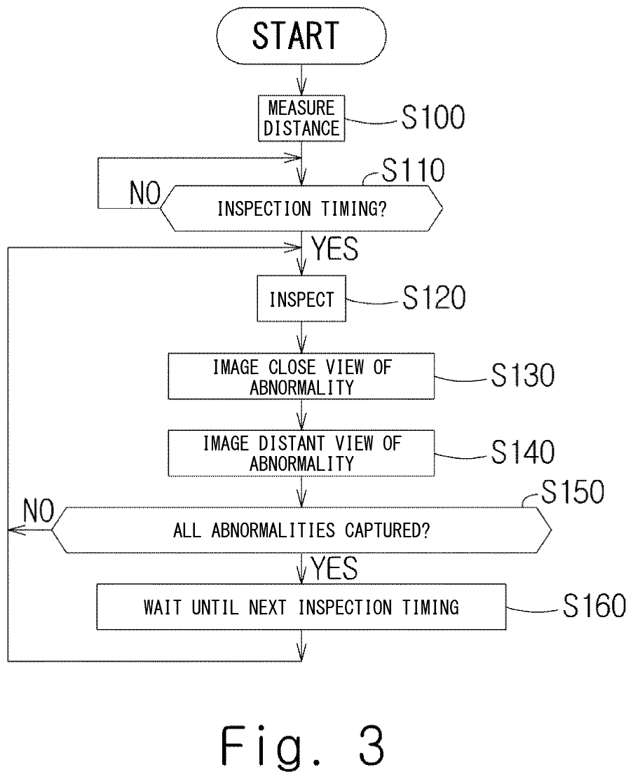

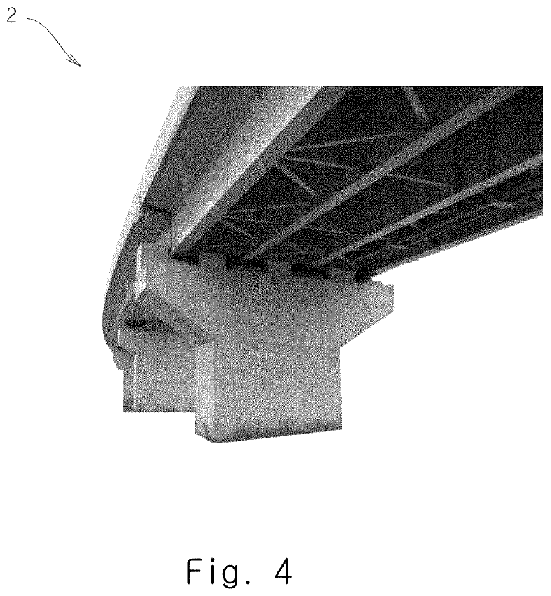

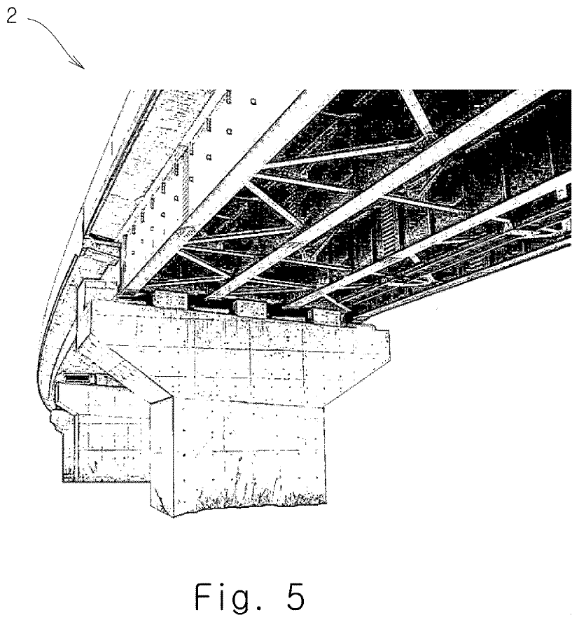

Here, a preliminary preparation flow performed before actually using the coordinate estimation device 1 will be described with reference to FIG. 3. As illustrated in FIG. 3, first, a point cloud of the bridge is prepared by measuring the distance of the bridge prior to the inspection of the bridge (S100). FIG. 4 illustrates a photograph of a bridge 2. FIG. 5 illustrates a point cloud of the bridge 2. Examples of a method for generating a point cloud of the bridge 2 illustrated in FIG. 5 include a method using Light Detection And Ranging (LiDAR) and a method using photogrammetry.

In the method using LiDAR, a distance of the bridge 2 is measured from various angles using LiDAR, and a plurality of point clouds output from LiDAR is synthesized using, for example, a registration technique such as Iterative Closest Point (ICP) to generate a point cloud of the bridge 2.

In the method using photogrammetry, a three-dimensional structure of the bridge 2 is restored by solving a geometric inverse problem from a plurality of captured images obtained by imaging the bridge 2 from various angles, thereby generating a point cloud of the bridge 2. A technique for restoring the three-dimensional structure of the bridge 2 from a plurality of captured images is typically the Structure from Motion (SfM). At this time, when Multi-View Stereo (MVS) is used in combination, a more precise point cloud of the bridge 2 can be generated.

In addition, a point cloud of the bridge 2 may be generated using both LiDAR and photogrammetry. That is, the point cloud of the bridge 2 may be generated by combining the point cloud of the bridge 2 generated using LiDAR and the point cloud of the bridge 2 generated by photogrammetry using the above-described registration technique.

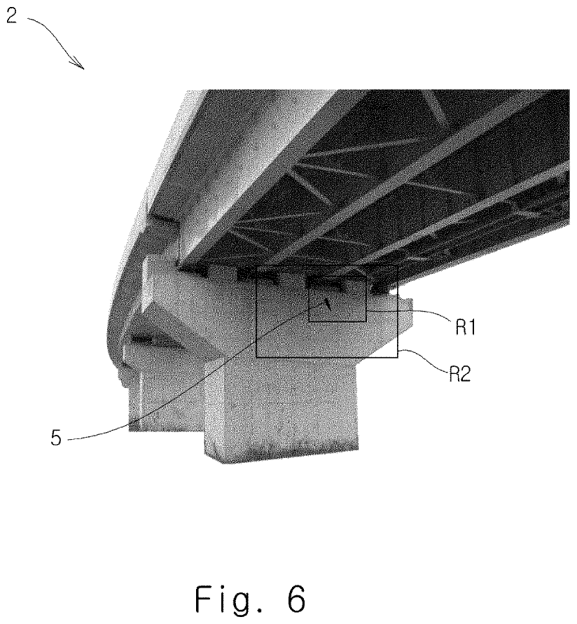

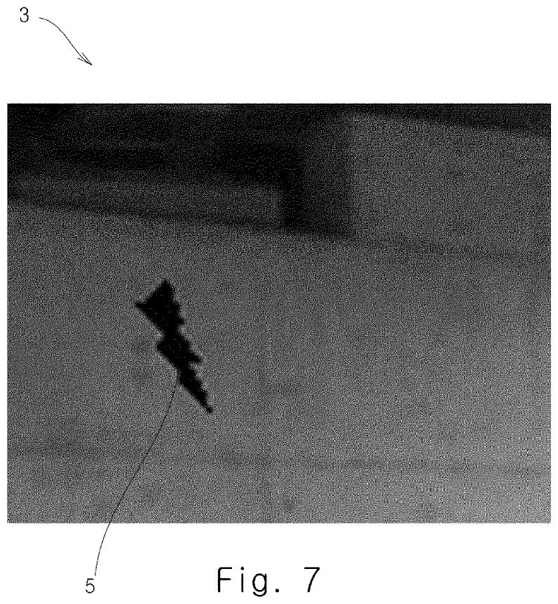

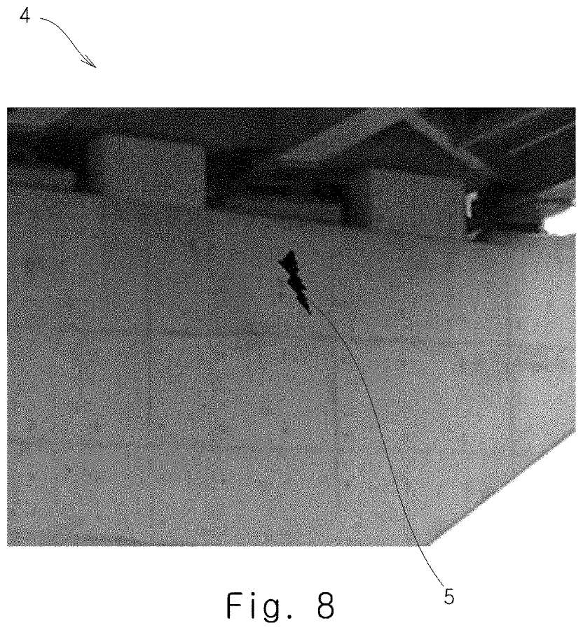

Returning to FIG. 3, when an inspection timing set in a span such as, for example, once every 5 years arrives (S110: YES), the inspector visually inspects the bridge 2 and inspects for presence/absence of abnormality of the bridge 2 (S120). In a case where there is abnormality on the bridge 2, the inspector images a close view image of the abnormality with the image capturing apparatus (S130). Subsequently, the inspector images the distant view image of the abnormality with the image capturing apparatus (S140). Here, a close view image and a distant view image will be described with reference to FIGS. 6 to 8. In FIG. 6, a close view imaging region R1 (first imaging region) that is an imaging region of a close view image and a distant view imaging region R2 (second imaging region) that is an imaging region of a distant view image are indicated by rectangular solid lines. FIGS. 7 and 8 illustrate the close view image 3 and the distant view image 4, respectively. As illustrated in FIG. 6, both the close view imaging region R1 and the distant view imaging region R2 are imaging regions including an abnormality 5. The distant view imaging region R2 is an imaging region larger than the close view imaging region R1. The distant view imaging region R2 is an imaging region including at least the close view imaging region R1. In the present example embodiment, when the abnormality 5 is found on the bridge 2, the inspector first images the close view image 3 of the abnormality 5 on the telephoto side of the image capturing apparatus, and then images the distant view image 4 of the abnormality 5 on the wide-angle side of the image capturing apparatus. By using the telephoto side and the wide-angle side of the image capturing apparatus in this manner, the close view image 3 and the distant view image 4 can be captured in a short time. However, instead of this, the inspector may move to the vicinity of the abnormality 5 to image the close view image 3 of the abnormality 5, and may image the distant view image 4 of the abnormality 5 away from the abnormality 5.

In the present disclosure, “close view” and “distant view” merely define relative characteristics, and do not define absolute characteristics. The technical scope of the present disclosure should not be interpreted to deviate from the definition.

Returning to FIG. 3, after the close view image 3 and the distant view image 4 are captured for all abnormalities 5 (S150: YES), the inspector waits until the next inspection timing (S160), and executes steps S120 to S150 again when the next inspection timing arrives.

### Coordinate Estimation Device 1

Returning to FIG. 2, the coordinate estimation device 1 includes a Central Processing Unit (CPU) 1a, a memory 1b, a Liquid Crystal Display (LCD) 1c, and a medium R/W 1d.

The memory 1b includes a Random Access Memory (RAM), a Read Only Memory (ROM), a Hard Disc Drive (HDD), and the like. The memory 1b stores a control program.

The CPU 1a reads and executes the control program stored in the memory 1b. As a result, the control program causes hardware such as the CPU 1a to function as various functional units. The various functional units include a data accepting unit 10, a point cloud storage unit 11, an image storage unit 12, an alignment unit 13, a position/posture estimation unit 14, and a coordinate estimation unit 15. The various functional units include a superimposed image generation unit 20, a superimposed image output unit 21, a history DB 22, a history DB update unit 23, a history DB extraction unit 24, and a history image output unit 25.

In the present example embodiment, the coordinate estimation device 1 is achieved by a single device. Alternatively, however, the coordinate estimation device 1 may be achieved by distributed processing by a plurality of devices.

The data accepting unit 10 accepts a point cloud of the bridge 2, a plurality of close view images 3, and a plurality of distant view images 4 via the medium R/W 1d. The data accepting unit 10 stores the point cloud of the bridge 2 in the point cloud storage unit 11, and stores the plurality of close view images 3 and the plurality of distant view images 4 in the image storage unit 12.

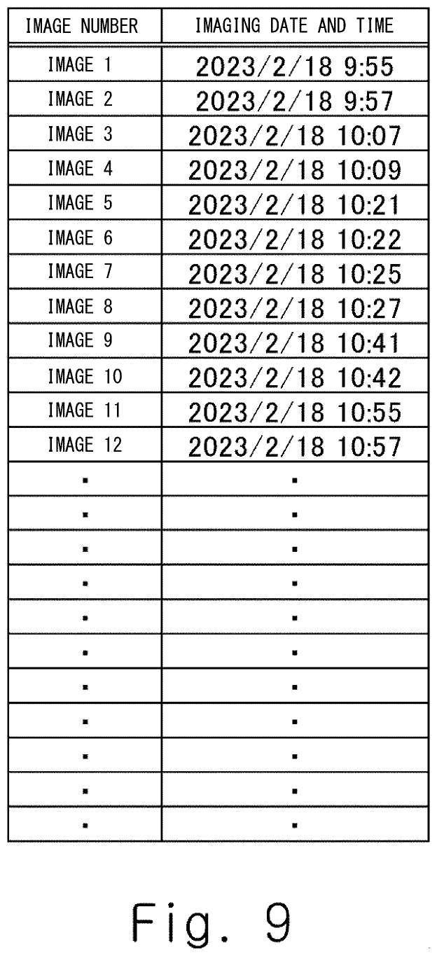

FIG. 9 is a data structure diagram of the image storage unit 12. The image storage unit 12 stores a plurality of images in association with the imaging date and time. In the present example embodiment, the inspector makes a rule to, when finding the abnormality 5 on the bridge 2, first image the close view image 3 of the abnormality 5 on the telephoto side of the image capturing apparatus, and then image the distant view image 4 of the abnormality 5 on the wide-angle side of the image capturing apparatus. In this case, since the close view image 3 and the distant view image 4 corresponding to the same abnormality 5 can be captured within several minutes, according to FIG. 9, it can be read that the image 1 is the close view image 3 and the distant view image 4 corresponding to the close view image 3 is the image 2. Similarly, the image 3 is the close view image 3, and the distant view image 4 corresponding to the close view image 3 is the image 4. Similarly, the image 5 is the close view image 3, and the distant view image 4 corresponding to the close view image 3 is the image 6. In the image storage unit 12 illustrated in FIG. 9, a plurality of images may be stored in association with an imaging condition such as, for example, a focal length in addition to the imaging date and time.

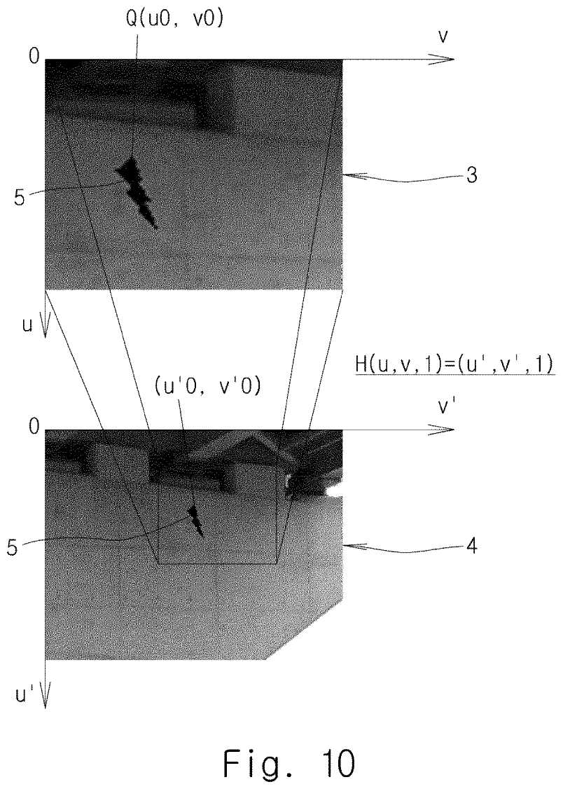

The alignment unit 13 aligns the close view image 3 and the distant view image 4 corresponding to the same abnormality 5. Specifically, the alignment unit 13 calculates a homography matrix established between the close view image 3 and the distant view image 4 corresponding to the same abnormality 5. FIG. 10 illustrates an explanatory diagram of the homography matrix H established between the close view image 3 and the distant view image 4 corresponding to the same abnormality 5. The alignment unit 13 detects feature points in each of the close view image 3 and the distant view image 4 corresponding to the same abnormality 5, and associates similar feature points with each other between the close view image 3 and the distant view image 4 corresponding to the same abnormality 5. The alignment unit 13 calculates the homography matrix based on the correspondence relationship between the feature points. At this time, the alignment unit 13 can ensure the reliability of the calculation result by calculating a homography matrix using Random Sample Consensus (RANSAC). As illustrated in FIG. 10, the homography matrix H is a matrix for converting arbitrary coordinates (u0, v0) in a close view coordinate system u-v, that is a coordinate system of the close view image 3, into coordinates (u′0, v′0) in a distant view coordinate system u′−v′, that is a coordinate system of the distant view image 4.

The position/posture estimation unit 14 estimates an imaging position/posture including an imaging position and an imaging posture in a point cloud coordinate system of that image capturing apparatus that has captured the distant view image 4 based on the point cloud of the bridge 2 and the distant view image 4. Here, the point cloud coordinate system is a coordinate system that defines coordinates of a point cloud of the bridge 2. The imaging position/posture can be estimated by a known technique. An example of the known technique is “C. Jaramillo, et al., “6-DoF pose localization in 3d point-cloud dense maps using a monocular camera,” 2013”. In short, the imaging position/posture can be estimated by repeatedly comparing the projection image obtained by projecting the point cloud of the bridge 2 with an arbitrary imaging position/posture with the distant view image 4 while changing the imaging position/posture, and searching for the imaging position/posture in such a way that both images match as much as possible. At this time, the position/posture estimation unit 14 can also simultaneously obtain an imaging condition of the distant view image 4. The imaging condition is typically a focal length.

The coordinate estimation unit 15 estimates specific pixel coordinates in a point cloud coordinate system of at least one specific pixel Q, that is an arbitrary pixel of the close view image 3, based on the point cloud of the bridge 2, the alignment result by the alignment unit 13, and the imaging position/posture estimated by the position/posture estimation unit 14. That is, as illustrated in FIG. 10, the coordinate estimation unit 15 calculates coordinates of at least one specific pixel Q in the distant view coordinate system u′−v′ based on the homography matrix H serving as the alignment result by the alignment unit 13.

The coordinate estimation unit 15 estimates the specific pixel coordinates based on the point cloud of the bridge 2, the calculation result, and the imaging position/posture estimated by the position/posture estimation unit 14.

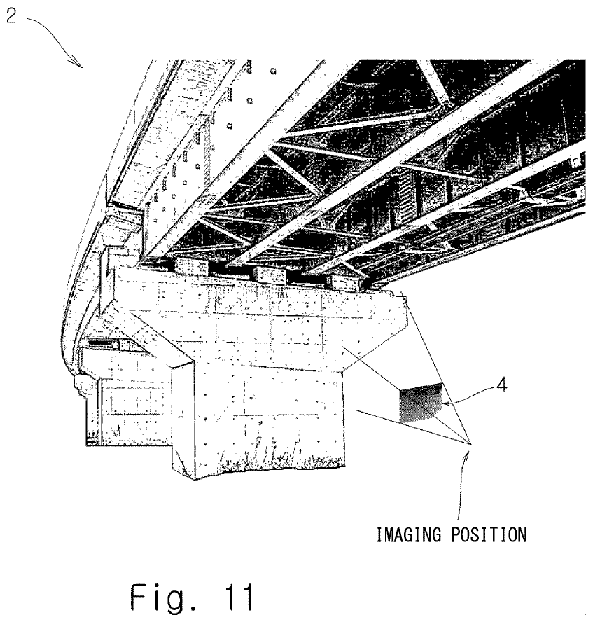

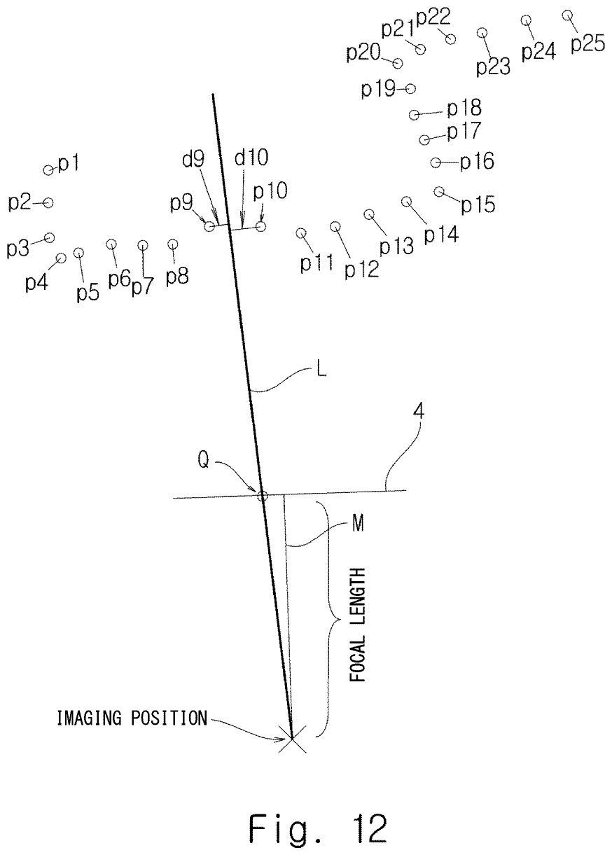

FIG. 11 illustrates a positional relationship among the imaging position, the distant view image 4, and the point cloud. FIG. 12 is a diagram for explaining the collision determination between a projection line L extending from the imaging position and the point cloud. As illustrated in FIGS. 11 and 12, the coordinate estimation unit 15 sets the distant view image 4 at a position separated from the imaging position by the focal length at the time of imaging toward the imaging direction in the point cloud coordinate system. At this time, a line segment M passing through the center point of the distant view image 4 and orthogonal to the distant view image 4 passes through the imaging position. In this state, the coordinate estimation unit 15 calculates the projection line L emitted from the imaging position toward the specific pixel Q converted into the distant view coordinate system u′−v′, and executes collision determination between the projection line L and the bridge 2. The projection line L is calculated as an equation of a line segment in the point cloud coordinate system. Then, the specific pixel coordinates of the specific pixel Q in the point cloud coordinate system are estimated based on the determination result.

However, as illustrated in FIG. 12, since the bridge 2 is expressed by a point cloud, it is practically impossible for the projection line L to collide with the point cloud of the bridge 2. Therefore, the coordinate estimation unit 15 extracts, from the point cloud of the bridge 2, a partial point cloud whose distance to the projection line L is equal to or less than a predetermined value among the points p1 to p25 of the bridge 2. In the example of FIG. 12, a shortest distance d9 between point p9 and the projection line L and a shortest distance d10 between point p10 and the projection line L are equal to or less than a predetermined value. Therefore, the coordinate estimation unit 15 extracts point p9 and point p10 as a partial point cloud from the point cloud (points p1 to p25) of the bridge 2. Then, the coordinate estimation unit 15 selects a point closest to the imaging position out of point p9 and point p10. In the example of FIG. 12, point p10 is slightly closer to the imaging position than point p9. Therefore, the coordinate estimation unit 15 selects point p10 as the point closest to the imaging position out of point p9 and point p10, and estimates the specific pixel coordinates as the coordinates in the point cloud coordinate system of the specific pixel Q of the close view image 3 based on the coordinates of point p10. In short, the specific pixel coordinates in the point cloud coordinate system of the specific pixel Q of the close view image 3 coincide with the coordinates of point p10.

Here, as illustrated in FIG. 10, the abnormality 5 in the close view image 3 generally extends over a plurality of pixels. Therefore, the coordinate estimation unit 15 estimates a plurality of specific pixel coordinates by executing collision determination on each of a plurality of pixels constituting the abnormality 5 in the close view image 3. Alternatively, in order to suppress the calculation cost, the coordinate estimation unit 15 may sample few pixels from the plurality of pixels constituting the abnormality 5 in the close view image 3 and execute the collision determination on each of the few sampled pixels. In this case, a pixel that has not been sampled may be estimated from specific pixel coordinates of the plurality of pixels adjacent to the pixel.

The coordinate estimation unit 15 can detect the abnormality 5 using, for example, a known Deep Neural Network (DNN) such as a Regions with Convolutional Neural Networks (R-CNN) or a You Only Look Once (YOLO).

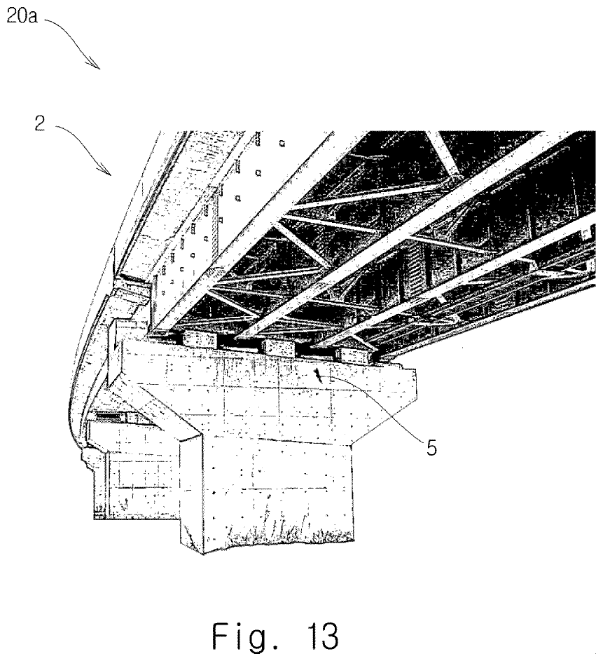

As illustrated in FIG. 13, the superimposed image generation unit 20 superimposes the close view image 3 on the point cloud of the bridge 2 based on the specific pixel coordinates estimated by the coordinate estimation unit 15.

Specifically, the superimposed image generation unit 20 generates a superimposed image 20a by superimposing a portion in the close view image 3 occupied by the abnormality 5 on a three-dimensional image including the point cloud of the bridge 2.

The superimposed image output unit 21 outputs the superimposed image 20a to the LCD 1c.

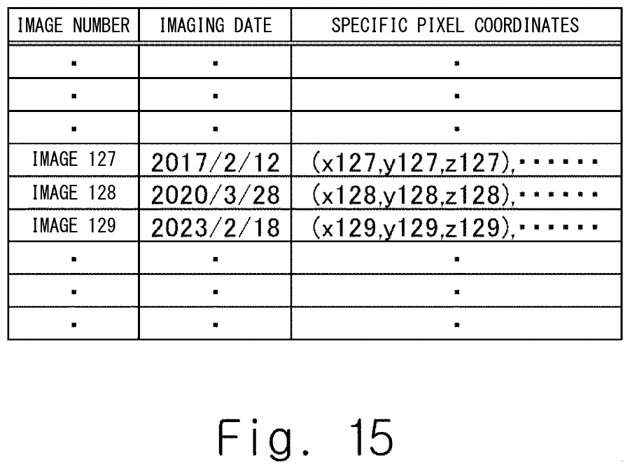

As illustrated in FIG. 15, the history DB 22 stores the close view image 3, the imaging date of the close view image 3, and the specific pixel coordinates of the portion in the close view image 3 occupied by the abnormality 5 in association with each other.

The history DB update unit 23 accumulates the estimation result by the coordinate estimation unit 15 in the history DB 22. Specifically, the history DB update unit 23 accumulates the close view image 3 processed this time by the coordinate estimation unit 15, the imaging date of the close view image 3, and the specific pixel coordinates of the portion of the close view image 3 occupied by the abnormality 5 in the history DB 22 in association with each other.

The history DB extraction unit 24 executes a search in the history DB 22 using, as a key, representative specific pixel coordinates of the abnormality 5 of the close view image 3 processed this time by the coordinate estimation unit 15, and extracts an image associated with specific pixel coordinates same as the specific pixel coordinates.

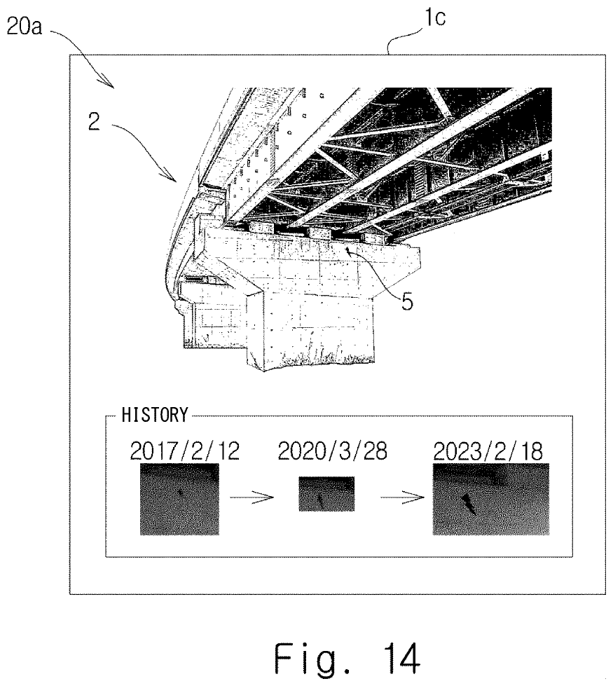

As illustrated in FIG. 14, the history image output unit 25 outputs the image extracted by the history DB extraction unit 24 together with the imaging date to the LCD 1c displaying the superimposed image 20a. This makes it possible to visually and easily grasp the temporal change in the abnormality 5.

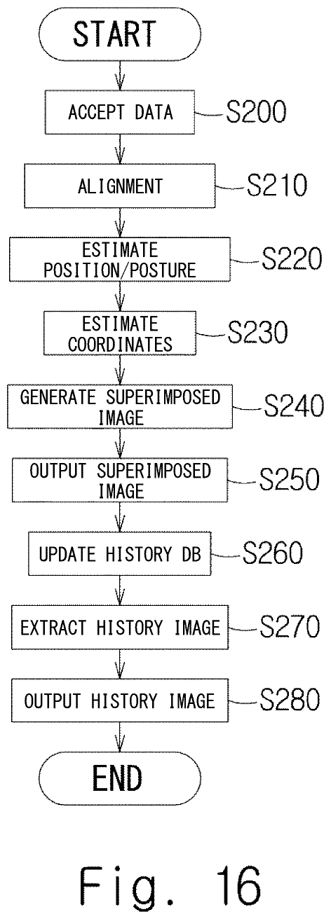

Next, a control flow of the coordinate estimation device 1 will be briefly described with reference to FIG. 16.

First, the data accepting unit 10 accepts a point cloud of the bridge 2, a plurality of close view images 3, and a plurality of distant view images 4 via the medium R/W 1d (S200).

Next, the alignment unit 13 aligns the close view image 3 and the distant view image 4 corresponding to the same abnormality 5 (S210).

Next, based on the point cloud of the bridge 2 and the distant view image 4, the position/posture estimation unit 14 estimates an imaging position/posture including an imaging position and an imaging posture in a point cloud coordinate system of an image capturing apparatus that has captured the distant view image 4 (S220).

Next, the coordinate estimation unit 15 estimates specific pixel coordinates in a point cloud coordinate system of at least one specific pixel Q, that is an arbitrary pixel of the close view image 3, based on the point cloud of the bridge 2, the alignment result by the alignment unit 13, and the imaging position/posture estimated by the position/posture estimation unit 14 (S230).

Next, the superimposed image generation unit 20 superimposes the close view image 3 on the point cloud of the bridge 2 based on the specific pixel coordinates estimated by the coordinate estimation unit 15 (S240).

Next, the superimposed image output unit 21 outputs the superimposed image 20a to the LCD 1c (S250).

Next, the history DB update unit 23 accumulates the estimation result by the coordinate estimation unit 15 in the history DB 22 (S260).

Next, the history DB extraction unit 24 executes a search in the history DB 22 using, as a key, representative specific pixel coordinates of the abnormality 5 of the close view image 3 processed this time by the coordinate estimation unit 15, and extracts an image associated with specific pixel coordinates same as the specific pixel coordinates (S270).

Next, the history image output unit 25 outputs the image extracted by the history DB extraction unit 24 to the LCD 1c together with the imaging date (S280).

Although the first example embodiment of the present disclosure has been described above, the above example embodiment has the following features.

As illustrated in FIG. 2, the coordinate estimation device 1 (coordinate estimation system) includes the alignment unit 13, the position/posture estimation unit 14, and the coordinate estimation unit 15. The alignment unit 13 aligns the close view image 3 and at least one distant view image 4. The close view image 3 is an image obtained by imaging a close view imaging region R1 (first imaging region) of the bridge 2 (object). At least one distant view image 4 is an image obtained by imaging a distant view imaging region R2 (second imaging region) that is larger than the close view imaging region R1 of the bridge 2 and includes the close view imaging region R1. The position/posture estimation unit 14 estimates an imaging position/posture including an imaging position and an imaging posture in a point cloud coordinate system of an image capturing apparatus that has captured at least one distant view image 4 based on the point cloud of the bridge 2 and the at least one distant view image 4. The coordinate estimation unit 15 estimates specific pixel coordinates in the point cloud coordinate system of at least one specific pixel Q, that is an arbitrary pixel of the close view image 3, based on the point cloud of the bridge 2, the alignment result by the alignment unit 13, and the imaging position/posture. According to the above configuration, when estimating the positional relationship between the point cloud and the close view image 3 (captured image) having greatly different resolutions from each other, the estimation can be performed without any problem by using at least one distant view image 4.

Furthermore, for example, as illustrated in FIGS. 10 and 12, the coordinate estimation unit 15 calculates coordinates on at least one distant view image 4 of at least one specific pixel Q based on the alignment result, and estimates the specific pixel coordinates based on a point cloud, the calculation result, and the imaging position/posture. According to the above configuration, the specific pixel coordinates can be efficiently estimated using the alignment result by the alignment unit 13.

Furthermore, for example, as illustrated in FIG. 12, the coordinate estimation unit 15 calculates a projection line L emitted from the imaging position toward at least one specific pixel Q based on the imaging position/posture, executes collision determination between the projection line L and the bridge 2, and estimates specific pixel coordinates based on the determination result.

According to the above configuration, the specific pixel coordinates can be estimated with a small calculation cost.

Furthermore, for example, as illustrated in FIG. 12, the coordinate estimation unit 15 extracts partial point clouds (point p9, point p10) whose distance to the projection line L is equal to or less than a predetermined value from the point cloud (points p1 to p25). The coordinate estimation unit 15 estimates specific pixel coordinates based on the coordinates of point p10 closest to the imaging position out of the partial point clouds (point p9, point p10).

According to the above configuration, pseudo collision determination between the projection line L and the point cloud can be achieved.

### Second Example Embodiment

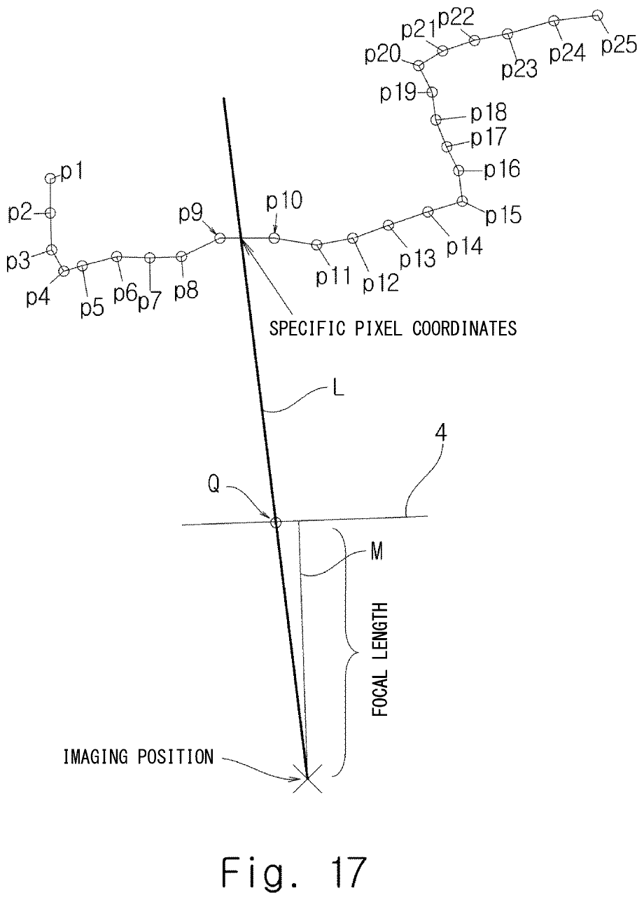

Hereinafter, a second example embodiment of the present disclosure will be described with reference to FIG. 17. Hereinafter, differences of the present example embodiment from the first example embodiment will be mainly described, and redundant description will be omitted.

In the first example embodiment, as illustrated in FIG. 12, the coordinate estimation unit 15 calculates the projection line L emitted from the imaging position toward the specific pixel Q based on the imaging position/posture estimated by the position/posture estimation unit 14. The coordinate estimation unit 15 executes collision determination between the projection line L and the bridge 2, and estimates specific pixel coordinates based on the determination result. However, since the bridge 2 is represented by a point cloud, there is a problem that it is practically impossible for the projection line L to collide with the point cloud of the bridge 2. Therefore, the coordinate estimation unit 15 extracts partial point clouds (point p9 and point p10) whose distance to the projection line L is equal to or less than a predetermined value from the point cloud, and estimates the specific pixel coordinates based on the coordinates of point p10 closest to the imaging position out of the partial point clouds (point p9 and point p10).

On the other hand, in the present example embodiment, as illustrated in FIG. 17, the coordinate estimation unit 15 converts the point cloud of the bridge 2 into mesh data, and executes the collision determination between the projection line L and the bridge 2 based on the mesh data. In this case, since the projection line L can always collide with the mesh expressed by the mesh data of the bridge 2, the collision determination between the projection line L and the bridge 2 can be executed without any problem.

### Third Example Embodiment

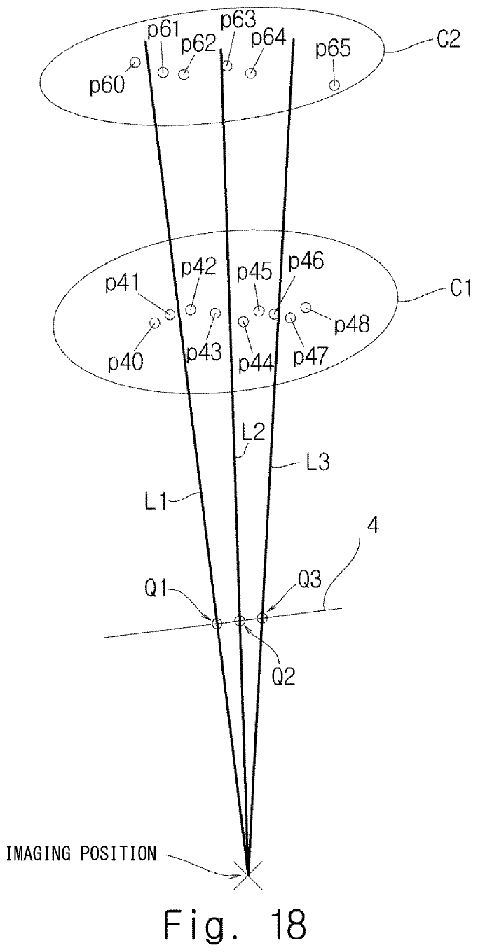

Hereinafter, a third example embodiment of the present disclosure will be described with reference to FIG. 18. Hereinafter, differences of the present example embodiment from the first example embodiment will be mainly described, and redundant description will be omitted.

In the first example embodiment, as illustrated in FIG. 12, the coordinate estimation unit 15 calculates the projection line L emitted from the imaging position toward the specific pixel Q based on the imaging position/posture estimated by the position/posture estimation unit 14. The coordinate estimation unit 15 executes collision determination between the projection line L and the bridge 2, and estimates specific pixel coordinates based on the determination result. However, since the bridge 2 is represented by a point cloud, there is a problem that it is practically impossible for the projection line L to collide with the point cloud of the bridge 2. Therefore, the coordinate estimation unit 15 extracts partial point clouds (point p9 and point p10) whose distance to the projection line L is equal to or less than a predetermined value from the point cloud, and estimates the specific pixel coordinates based on the coordinates of point p10 closest to the imaging position out of the partial point clouds (point p9 and point p10).

However, in the first example embodiment, the following problems may occur. Please refer to FIG. 18. FIG. 18 illustrates a conceptual diagram of when calculating specific pixel coordinates corresponding to a plurality of specific pixels Q. In FIG. 18, similarly to the first example embodiment, in a case where specific pixel coordinates are obtained for each specific pixel Q, the partial point clouds whose distance to the projection line L1 corresponding to the specific pixel Q1 becomes equal to or less than a predetermined value are point p41 and point p42. Similarly, the partial point cloud whose distance to the projection line L2 corresponding to the specific pixel Q2 is equal to or less than the predetermined value is point p63. Similarly, the partial point clouds whose distance to the projection line L3 corresponding to the specific pixel Q3 is equal to or less than the predetermined value are point p46 and point 47. Here, points p40 to p48 correspond to a point cloud on the front surface of the bridge 2 viewed from the imaging position estimated by the position/posture estimation unit 14, and points p60 to p65 correspond to a point cloud on the back surface of the bridge 2 viewed from the imaging position estimated by the position/posture estimation unit 14. In this case, the specific pixel coordinates corresponding to the specific pixel Q1, the specific pixel Q2, and the specific pixel Q3 are the coordinates of point p41, point p63, and point p47, respectively. Therefore, it is conceivable that a part of the abnormality 5 is scattered to coordinates far from the coordinates where the abnormality 5 originally exists in the superimposed image generated by the superimposed image generation unit 20. As a result, a part of the abnormality 5 may be substantially missing in the superimposed image generated by the superimposed image generation unit 20. This missing can be a major problem when measuring the size of the abnormality 5 on the digital twin.

Therefore, in the present example embodiment, the coordinate estimation unit 15 sets the predetermined value used for the collision determination to be larger than that in the first example embodiment, and then executes the collision determination as in the first example embodiment. In this case, the partial point clouds whose distance to the projection line L1 corresponding to the specific pixel Q1 is equal to or less than the predetermined value are point p41, point p42, point p60, and point p61. Similarly, the partial point clouds whose distance to the projection line L2 corresponding to the specific pixel Q2 is equal to or less than the predetermined value are point p43, point p44, and point p63. Similarly, the partial point clouds whose distance to the projection line L3 corresponding to the specific pixel Q3 is equal to or less than the predetermined value are point p46 and point 47.

Next, the coordinate estimation unit 15 executes clustering on all the partial point clouds extracted in the collision determination according to the distance from the imaging position estimated by the position/posture estimation unit 14. All the point clouds mean point p41, point p42, point p43, point p44, point p46, point 47, point p60, point p61, and point p63. As a result, a cluster C1 to which point p41, point p42, point p43, point p44, point p46, and the point 47 belong and a cluster C2 to which point p60, point p61, and point p63 belong are obtained.

Next, the coordinate estimation unit 15 selects one of the clusters C1 and C2 obtained by the clustering, and estimates specific pixel coordinates for each specific pixel Q based on the selected cluster. Specifically, the coordinate estimation unit 15 may select a cluster closest to the imaging position estimated by the position/posture estimation unit 14 among a plurality of clusters obtained by the clustering. In addition, the coordinate estimation unit 15 may select a cluster having the largest number of points among a plurality of clusters obtained by the clustering. Under any selection criterion, in the example of FIG. 18, the coordinate estimation unit 15 will select the cluster C1. Then, when obtaining the specific pixel coordinates for each specific pixel Q, the coordinate estimation unit 15 selects a point p closest to the imaging position estimated by the position/posture estimation unit 14 from among a plurality of points corresponding to the specific pixel Q and belonging to the cluster C1. For example, regarding the specific pixel Q1, the coordinate estimation unit 15 selects point p41 closest to the imaging position estimated by the position/posture estimation unit 14 out of point p41 and point p42. Furthermore, regarding the specific pixel Q2, the coordinate estimation unit 15 selects point p44 closest to the imaging position estimated by the position/posture estimation unit 14 out of point p43 and point p44. Moreover, regarding the specific pixel Q3, the coordinate estimation unit 15 selects point p47 closest to the imaging position estimated by the position/posture estimation unit 14 out of point p46 and point p47. Then, the coordinate estimation unit 15 estimates, for each specific pixel Q, specific pixel coordinates corresponding to the specific pixel Q based on the selected point. According to the above configuration, it is possible to prevent a part of the abnormality 5 from being substantially missing in the superimposed image generated by the superimposed image generation unit 20.

In short, the present example embodiment has the following features.

That is, at least one specific pixel Q includes a plurality of specific pixels Q. The coordinate estimation unit 15 extracts, from the point cloud, a partial point cloud whose distance to the projection line L is equal to or less than a predetermined value for each specific pixel Q. The coordinate estimation unit 15 clusters all the partial point clouds. Then, the coordinate estimation unit 15 estimates specific pixel coordinates for each specific pixel Q based on any of a plurality of clusters obtained by clustering. According to the above configuration, it is possible to prevent a part of the abnormality 5 from being substantially missing in the superimposed image generated by the superimposed image generation unit 20.

### Fourth Example Embodiment

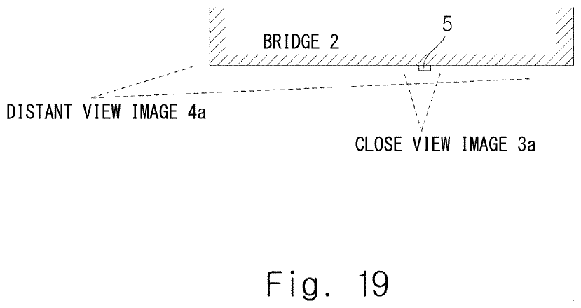

Next, a fourth example embodiment of the present disclosure will be described with reference to FIGS. 19 to 23. Hereinafter, differences of the present example embodiment from the first example embodiment will be mainly described, and redundant description will be omitted.

In the first example embodiment, the inspector makes a rule to, when finding the abnormality 5 on the bridge 2, first image the close view image 3 of the abnormality 5 on the telephoto side of the image capturing apparatus, and then image the distant view image 4 of the abnormality 5 on the wide-angle side of the image capturing apparatus. In this case, since the close view image 3 and the distant view image 4 corresponding to the same abnormality 5 can be captured within several minutes, according to FIG. 9, it can be read that the image 1 is the close view image 3 and the distant view image 4 corresponding to the close view image 3 is the image 2.

However, even if the imaging rules of the close view image 3 and the distant view image 4 are defined as described above, the imaging rules are not necessarily complied with at the time of actual inspection. For example, in a case where imaging of the close view image 3 fails due to camera shake, the close view image 3 will be captured again for the same abnormality 5. Furthermore, there may be a case where the user forgets to image the distant view image 4 corresponding to the close view image 3. In this case, in FIG. 9, there is a possibility that the correspondence relationship between the close view image 3 and the distant view image 4 cannot be accurately grasped only from the imaging date and time.

As a result, as illustrated in FIG. 19, it is assumed that the close view image 3a obtained by imaging the abnormality 5 of the bridge 2 from the front surface and the distant view image 4a obtained by imaging the abnormality 5 of the bridge 2 at a narrow angle correspond to each other, and estimation of specific pixel coordinates regarding the specific pixel of the close view image 3a will be executed. In this case, it is conceivable that the estimation accuracy of the specific pixel coordinates deteriorates due to the following reasons. That is, firstly, since the area of the close view image 3a occupied in the distant view image 4a is reduced, the calculation accuracy of the homography matrix H is degraded in the first place. Secondly, since the distant view image 4a is an image obtained by imaging the abnormality 5 of the bridge 2 at a narrow angle, the projection line L used in the collision determination by the coordinate estimation unit 15 is also generated at a narrow angle with respect to the abnormality 5 of the bridge 2, and hence it is conceivable that a partial point cloud whose distance to the projection line L is equal to or less than a predetermined value is shifted as a whole in such a way as to approach the imaging position of the distant view image 4a.

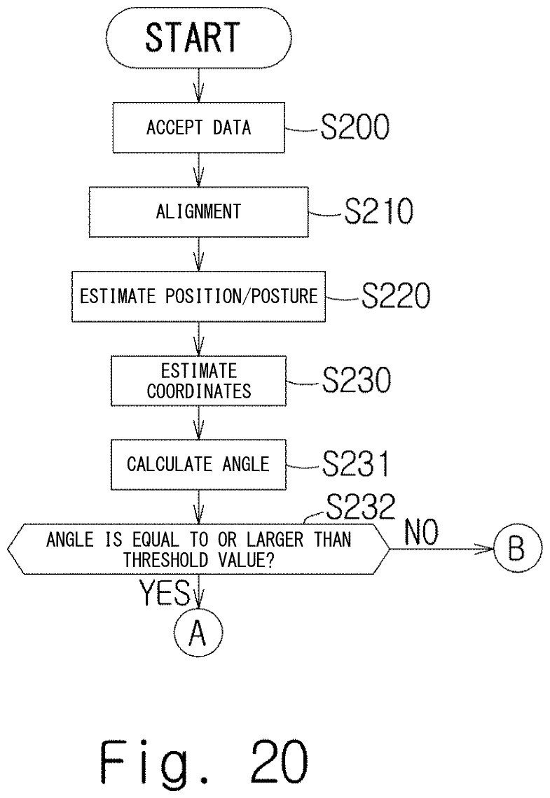

Therefore, in the present example embodiment, the coordinate estimation unit 15 determines whether the distant view image 4 obtained by imaging the abnormality 5 is captured from a narrow angle, and in a case where the distant view image 4 is obtained from a narrow angle, the specific pixel coordinates are estimated again using another distant view image 4 obtained by imaging the abnormality 5. Hereinafter, the operation of the coordinate estimation unit 15 will be described with reference to FIGS. 20 to 23.

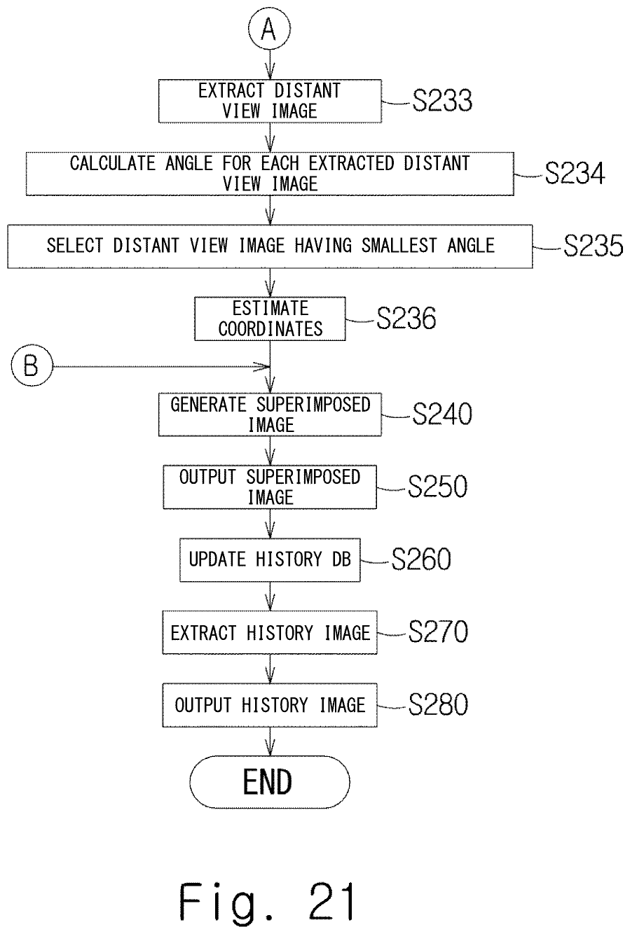

FIGS. 20 and 21 illustrate an operation flow of the coordinate estimation device 1. In the operation flow illustrated in FIGS. 20 and 21, steps S200 to S230 and steps S240 to S280 are the same as those of the first example embodiment, and thus description thereof will be appropriately omitted.

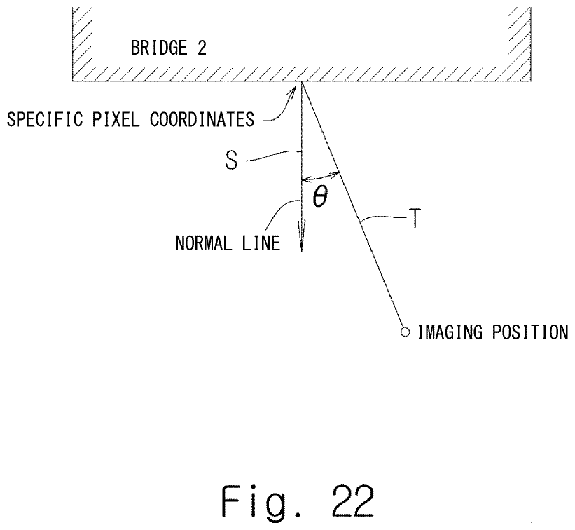

Referring to FIG. 20, the coordinate estimation unit 15 estimates specific pixel coordinates based on the close view image 3a and the distant view image 4a estimated to have a correspondence relationship with each other (S230). Next, as illustrated in FIG. 22, the coordinate estimation unit 15 calculates an angle θ formed by a normal line S of the surface of the bridge 2 at the specific pixel coordinates and a line segment T connecting the imaging position of the distant view image 4a estimated by the position/posture estimation unit 14 and the specific pixel coordinates (S231). Then, the coordinate estimation unit 15 determines whether the calculated angle θ is equal to or larger than a threshold value (S232). In a case where the coordinate estimation unit 15 determines that the calculated angle θ is not equal to or larger than the threshold value, the coordinate estimation unit 15 advances the processing to step S240. That is, in a case where the calculated angle θ is not equal to or larger than the threshold value, the estimation accuracy of the specific pixel coordinates is secured for the reasons described above. In a case where the coordinate estimation unit 15 determines that the calculated angle θ is equal to or larger than the threshold value, the coordinate estimation unit 15 advances the processing to step S233 illustrated in FIG. 21.

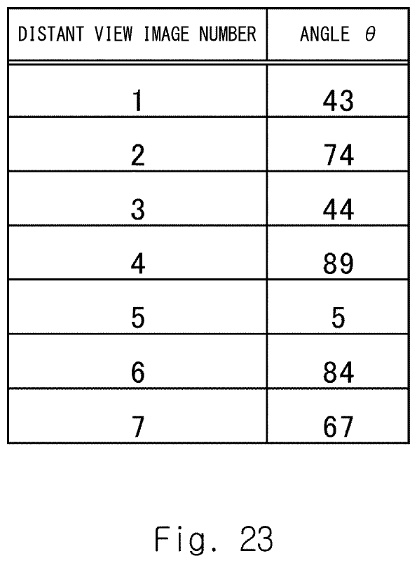

In step S233, the coordinate estimation unit 15 extracts a plurality of distant view images 4 including the specific pixel coordinates estimated in S230 in the imaging range from among the plurality of distant view images 4 stored in the image storage unit 12 (S233). Next, the coordinate estimation unit 15 calculates specific pixel coordinates for each of the extracted distant view images 4, and calculates the angle θ illustrated in FIG. 22 for each of the distant view images 4 (S234). Then, as illustrated in FIG. 23, the coordinate estimation unit 15 stores the plurality of distant view images 4 extracted by the coordinate estimation unit 15 in step S233 and the angle θ calculated by the coordinate estimation unit 15 in step S234 in the memory 1b in association with each other.

Next, the coordinate estimation unit 15 selects the distant view image 4 (distant view Image number No. 5) having the smallest angle θ among the plurality of distant view images 4 extracted in step S233 (S235). Then, the coordinate estimation unit 15 estimates the specific pixel coordinates of the specific pixel Q again based on the selected distant view image 4 (S236), and advances the processing to S240. As a result, even when the close view image 3 and the distant view image 4 corresponding to each other cannot be accurately acquired from the image storage unit 12 illustrated in FIG. 9, the specific pixel coordinates can be estimated with high accuracy.

In short, the example embodiment described above has the following features.

That is, the at least one distant view image 4 includes a plurality of distant view images 4 having different imaging positions/postures. The coordinate estimation unit 15 estimates specific pixel coordinates for each distant view image 4, and calculates, for each distant view image 4, an angle θ formed by a normal line S of the bridge 2 at the specific pixel coordinates and a line segment T connecting the imaging position and the specific pixel coordinates (S234).

Then, the coordinate estimation unit 15 estimates specific pixel coordinates based on the distant view image 4 having the smallest angle θ among the plurality of distant view images 4 (S236). According to the above configuration, even when the correspondence relationship between the close view image 3 and the distant view image 4 is not secured, the specific pixel coordinates can be estimated with high accuracy.

### Fifth Example Embodiment

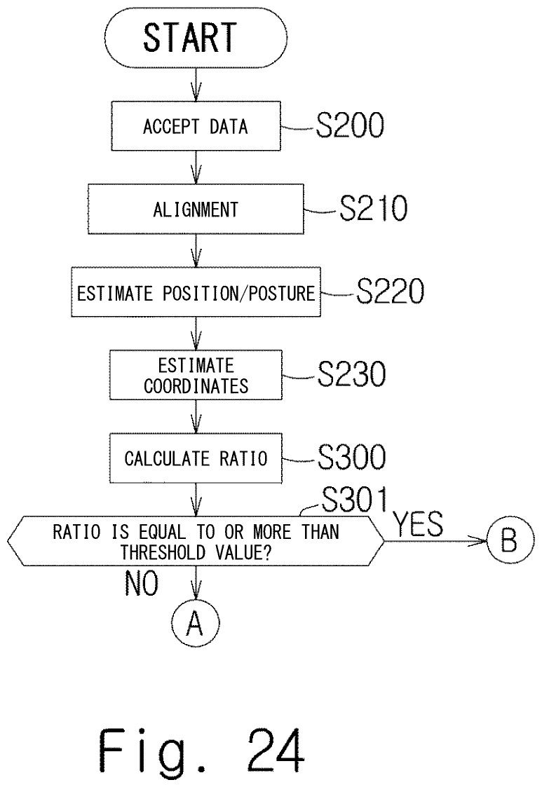

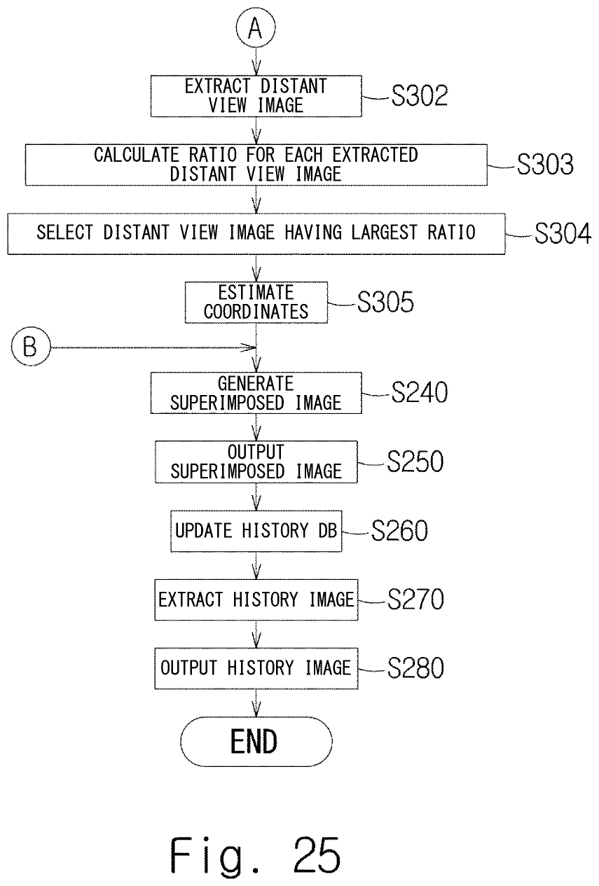

Next, a fifth example embodiment of the present disclosure will be described with reference to FIGS. 24 and 25. Hereinafter, differences of the present example embodiment from the fourth example embodiment will be mainly described, and redundant description will be omitted.

In the fourth example embodiment, as illustrated in FIG. 22, the angle θ is obtained for each distant view image 4, and the optimum distant view image 4 is selected based on the angle θ, thereby ensuring the estimation accuracy of the specific pixel coordinates.

On the other hand, in the present example embodiment, the ratio that is occupied by the close view image 3 is obtained for each distant view image 4, and the optimum distant view image 4 is selected based on the ratio, thereby ensuring the estimation accuracy of the specific pixel coordinates. Specifically, it is as follows.

FIGS. 24 and 25 illustrate an operation flow of the coordinate estimation device 1. In the operation flow illustrated in FIGS. 24 and 25, steps S200 to S230 and steps S240 to S280 are the same as those of the first example embodiment, and thus description thereof will be appropriately omitted.

Referring to FIG. 24, the coordinate estimation unit 15 estimates specific pixel coordinates based on the close view image 3a and the distant view image 4a estimated to have a correspondence relationship with each other (S230). Next, the coordinate estimation unit 15 calculates the ratio that is occupied by the close view image 3a in the distant view image 4a (S300). Typically, the area occupied by the close view image 3 in the distant view image 4 can be easily obtained by converting the coordinates of the four corners of the close view image 3a into the distant view coordinate system u′−v′ of the distant view image 4a based on the homography matrix H calculated by the alignment unit 13. Therefore, the coordinate estimation unit 15 can calculate the ratio by dividing the area occupied by the close view image 3 in the distant view image 4 by the area of the distant view image 4. Then, the coordinate estimation unit 15 determines whether the calculated ratio is equal to or more than a threshold value (S301). When the coordinate estimation unit 15 determines that the calculated ratio is equal to or more than the threshold value, the coordinate estimation unit 15 advances the processing to step S240. That is, when the calculated ratio is equal to or more than the threshold value, the estimation accuracy of the specific pixel coordinates is secured for the reasons described above. On the other hand, when the coordinate estimation unit 15 determines that the calculated angle θ is not equal to or larger than the threshold value, the coordinate estimation unit 15 proceeds to step S302 illustrated in FIG. 25.

In step S2302, the coordinate estimation unit 15 extracts a plurality of distant view images 4 including the specific pixel coordinates estimated in S230 in the imaging range from among the plurality of distant view images 4 stored in the image storage unit 12 (S302). Next, the coordinate estimation unit 15 calculates the homography matrix H and the above-described ratio for each of the extracted distant view images 4 (S303). Then, the coordinate estimation unit 15 stores the plurality of distant view images 4 extracted by the coordinate estimation unit 15 in step S302 and the ratio calculated by the coordinate estimation unit 15 in step S303 in the memory 1b in association with each other.

Next, the coordinate estimation unit 15 selects the distant view image 4 having the largest ratio among the plurality of distant view images 4 extracted in step S303 (S304). Then, the coordinate estimation unit 15 estimates the specific pixel coordinates of the specific pixel Q again based on the selected distant view image 4 (S305), and advances the processing to S240. According to the above configuration, even when the correspondence relationship between the close view image 3 and the distant view image 4 is not secured, the specific pixel coordinates can be estimated with high accuracy.

In short, the example embodiment described above has the following features.

That is, the at least one distant view image 4 includes a plurality of distant view images 4 having different imaging positions/postures. The distant view imaging region R2 of the plurality of distant view images 4 is larger than the close view imaging region R1 of the close view image 3, and includes at least the close view imaging region R1 of the close view image 3. Then, the coordinate estimation unit 15 estimates the specific pixel coordinates based on the distant view image 4 having the largest ratio that is occupied by the close view image 3 among the plurality of distant view images 4. According to the above configuration, even when the correspondence relationship between the close view image 3 and the distant view image 4 is not secured, the specific pixel coordinates can be estimated with high accuracy.

In the above-described example, the program can be stored in various types of non-transitory computer-readable medium and supplied to a computer.

The non-transitory computer-readable medium includes various types of tangible storage medium. Examples of the non-transitory computer-readable medium include magnetic recording medium (for example, flexible disks, magnetic tapes, or hard disk drives), and magneto-optical recording medium (for example, magneto-optical disks). Examples of non-transitory computer-readable medium further include a CD-ROM (Read Only Memory), a CD-R, a CD-R/W, a semiconductor memory (e.g., a mask ROM). Examples of non-transitory computer-readable medium further include a PROM (Programmable ROM), an EPROM (Erasable PROM), a flash ROM, and a RAM (random access memory). The program may be supplied to the computer by various types of transitory computer-readable medium. Examples of transitory computer-readable medium include electrical signals, optical signals, and electromagnetic waves. The transitory computer-readable medium can provide the program to the computer via a wired communication line such as an electric wire and optical fibers or a wireless communication line.

Some or all of the above-described example embodiments may be described as the following Supplementary Notes, but are not limited to the following Supplementary Notes.

### Supplementary Note 1

A coordinate estimation system including:
an alignment means for aligning a close view image obtained by imaging a first imaging region of an object with at least one distant view image obtained by imaging a second imaging region that is larger than the first imaging region of the object and includes the first imaging region;
a position/posture estimation means for estimating an imaging position/posture including an imaging position and an imaging posture in a point cloud coordinate system of an image capturing apparatus that has captured the at least one distant view image based on a point cloud of the object and the at least one distant view image; and
a coordinate estimation means for estimating specific pixel coordinates in a point cloud coordinate system of at least one specific pixel that is an arbitrary pixel of the close view image based on the point cloud, an alignment result by the alignment means, and the imaging position/posture.

### Supplementary Note 2

The coordinate estimation system according to supplementary note 1, in which the coordinate estimation means calculates coordinates in the at least one distant view image of the at least one specific pixel based on the alignment result, and estimates the specific pixel coordinates based on the point cloud, the calculation result, and the imaging position/posture.

### Supplementary Note 3

The coordinate estimation system according to supplementary note 1, in which
the at least one distant view image includes a plurality of distant view images having different imaging positions/postures from each other, and
the coordinate estimation means
estimates the specific pixel coordinates for each of the distant view images,
calculates, for each of the distant view images, an angle formed by a normal line of the object at the specific pixel coordinates and a line segment connecting the imaging position and the specific pixel coordinates, and
estimates the specific pixel coordinates based on a distant view image having the smallest angle among the plurality of distant view images.

### Supplementary Note 4

The coordinate estimation system according to supplementary note 1, in which
the at least one distant view image includes a plurality of distant view images having different imaging positions/postures from each other, and
the coordinate estimation means estimates the specific pixel coordinates based on a distant view image having a largest ratio that is occupied by the close view image among the plurality of distant view images.

### Supplementary Note 5

The coordinate estimation system according to supplementary note 1, in which the coordinate estimation means calculates a projection line emitted from the imaging position toward the at least one specific pixel based on the imaging position/posture, executes collision determination between the projection line and the object, and estimates the specific pixel coordinates based on the determination result.

### Supplementary Note 6

The coordinate estimation system according to supplementary note 5, in which the coordinate estimation means extracts, from the point cloud, a partial point cloud whose distance to the projection line is equal to or less than a predetermined value, and estimates the specific pixel coordinates based on coordinates of a point closest to the imaging position in the partial point cloud.

### Supplementary Note 7

The coordinate estimation system according to supplementary note 5, in which
the coordinate estimation means converts the point cloud into mesh data, and
executes a collision determination between the projection line and the object based on the mesh data.

### Supplementary Note 8

The coordinate estimation system according to supplementary note 5, in which
the at least one specific pixel includes a plurality of specific pixels, and
the coordinate estimation means,
extracts, from the point cloud, a partial point cloud whose distance to the projection line is equal to or less than a predetermined value for each of the specific pixels,
clusters all the partial point clouds, and
estimates the specific pixel coordinates for each of the specific pixels based on any of a plurality of clusters obtained by the clustering.

### Supplementary Note 9

A coordinate estimation device including:
an alignment means for aligning a close view image obtained by imaging a first imaging region of an object with at least one distant view image obtained by imaging a second imaging region that is larger than the first imaging region of the object and includes the first imaging region;
a position/posture estimation means for estimating an imaging position/posture including an imaging position and an imaging posture in a point cloud coordinate system of an image capturing apparatus that has captured the at least one distant view image based on a point cloud of the object and the at least one distant view image; and
a coordinate estimation means for estimating specific pixel coordinates in a point cloud coordinate system of at least one specific pixel that is an arbitrary pixel of the close view image based on the point cloud, an alignment result by the alignment means, and the imaging position/posture.

### Supplementary Note 10

The coordinate estimation device according to supplementary note 9, in which the coordinate estimation means calculates coordinates in the at least one distant view image of the at least one specific pixel based on the alignment result, and estimates the specific pixel coordinates based on the point cloud, the
calculation result, and the imaging position/posture.

### Supplementary Note 11

The coordinate estimation device according to supplementary note 9, in which
the at least one distant view image includes a plurality of distant view images having different imaging positions/postures from each other, and
the coordinate estimation means
estimates the specific pixel coordinates for each of the distant view images,
calculates, for each of the distant view images, an angle formed by a normal line of the object at the specific pixel coordinates and a line segment connecting the imaging position and the specific pixel coordinates, and
estimates the specific pixel coordinates based on a distant view image having the smallest angle among the plurality of distant view images.

### Supplementary Note 12

The coordinate estimation device according to supplementary note 9, in which
the at least one distant view image includes a plurality of distant view images having different imaging positions/postures from each other, and
the coordinate estimation means estimates the specific pixel coordinates based on a distant view image having a largest ratio that is occupied by the close view image among the plurality of distant view images.

### Supplementary Note 13

The coordinate estimation device according to supplementary note 9, in which the coordinate estimation means calculates a projection line emitted from the imaging position toward the at least one specific pixel based on the imaging position/posture, executes collision determination between the projection line and the object, and estimates the specific pixel coordinates based on the determination result.

### Supplementary Note 14

The coordinate estimation device according to supplementary note 13, in which the coordinate estimation means extracts, from the point cloud, a partial point cloud whose distance to the projection line is equal to or less than a predetermined value, and estimates the specific pixel coordinates based on coordinates of a point closest to the imaging position in the partial point cloud.

### Supplementary Note 15

The coordinate estimation device according to supplementary note 13, in which
the coordinate estimation means converts the point cloud into mesh data, and
executes a collision determination between the projection line and the object based on the mesh data.

### Supplementary Note 16

The coordinate estimation device according to supplementary note 13, in which
the at least one specific pixel includes a plurality of specific pixels, and
the coordinate estimation means,
extracts, from the point cloud, a partial point cloud whose distance to the projection line is equal to or less than a predetermined value for each of the specific pixels,
clusters all the partial point clouds, and
estimates the specific pixel coordinates for each of the specific pixels based on any of a plurality of clusters obtained by the clustering.

### Supplementary Note 17

A coordinate estimation method including:
alignment step in which a computer aligns a close view image obtained by imaging a first imaging region of an object with at least one distant view image obtained by imaging a second imaging region that is larger than the first imaging region of the object and includes the first imaging region;
a position/posture estimation step in which the computer estimates an imaging position/posture including an imaging position and an imaging posture in a point cloud coordinate system of an image capturing apparatus that has captured the at least one distant view image based on a point cloud of the object and the at least one distant view image; and
a coordinate estimation step in which the computer estimates specific pixel coordinates in a point cloud coordinate system of at least one specific pixel that is an arbitrary pixel of the close view image based on the point cloud, an alignment result by the alignment step, and the imaging position/posture.

### Supplementary Note 18

The coordinate estimation method according to supplementary note 17, in which the coordinate estimation step includes calculating coordinates in the at least one distant view image of the at least one specific pixel based on the alignment result, and estimating the specific pixel coordinates based on the point cloud, the calculation result, and the imaging position/posture.

### Supplementary Note 19

The coordinate estimation method according to supplementary note 17, in which
the at least one distant view image includes a plurality of distant view images having different imaging positions/postures from each other, and
the coordinate estimation step includes,
estimating the specific pixel coordinates for each of the distant view images,
calculating, for each of the distant view images, an angle formed by a normal line of the object at the specific pixel coordinates and a line segment connecting the imaging position and the specific pixel coordinates, and
estimating the specific pixel coordinates based on a distant view image having the smallest angle among the plurality of distant view images.

### Supplementary Note 20

The coordinate estimation method according to supplementary note 17, in which
the at least one distant view image includes a plurality of distant view images having different imaging positions/postures from each other, and
the coordinate estimation step includes estimating the specific pixel coordinates based on a distant view image having a largest ratio that is occupied by the close view image among the plurality of distant view images.

### Supplementary Note 21

The coordinate estimation method according to supplementary note 17, in which the coordinate estimation step includes calculating a projection line emitted from the imaging position toward the at least one specific pixel based on the imaging position/posture, executing collision determination between the projection line and the object, and estimating the specific pixel coordinates based on the determination result.

### Supplementary Note 22

The coordinate estimation method according to supplementary note 21, in which the coordinate estimation step includes extracting, from the point cloud, a partial point cloud whose distance to the projection line is equal to or less than a predetermined value, and estimating the specific pixel coordinates based on coordinates of a point closest to the imaging position in the partial point cloud.

### Supplementary Note 23

The coordinate estimation method according to supplementary note 21, in which
the coordinate estimation step includes converting the point cloud into mesh data, and
executing a collision determination between the projection line and the object based on the mesh data.

### Supplementary Note 24

The coordinate estimation method according to supplementary note 21, in which
the at least one specific pixel includes a plurality of specific pixels, and
the coordinate estimation step includes,
extracting, from the point cloud, a partial point cloud whose distance to the projection line is equal to or less than a predetermined value for each of the specific pixels,
clustering all the partial point clouds, and
estimating the specific pixel coordinates for each of the specific pixels based on any of a plurality of clusters obtained by the clustering.

### Supplementary Note 25

A program for causing a computer to execute:
alignment step of aligning a close view image obtained by imaging a first imaging region of an object with at least one distant view image obtained by imaging a second imaging region that is larger than the first imaging region of the object and includes the first imaging region;
a position/posture estimation step of estimating an imaging position/posture including an imaging position and an imaging posture in a point cloud coordinate system of an image capturing apparatus that has captured the at least one distant view image based on a point cloud of the object and the at least one distant view image; and
a coordinate estimation step of estimating specific pixel coordinates in a point cloud coordinate system of at least one specific pixel that is an arbitrary pixel of the close view image based on the point cloud, an alignment result by the alignment step, and the imaging position/posture.

### Supplementary Note 26

The program according to supplementary note 25, in which the coordinate estimation step includes calculating coordinates in the at least one distant view image of the at least one specific pixel based on the alignment result, and estimating the specific pixel coordinates based on the point cloud, the calculation result, and the imaging position/posture.

### Supplementary Note 27

The program according to supplementary note 25, in which
the at least one distant view image includes a plurality of distant view images having different imaging positions/postures from each other, and
the coordinate estimation step includes,
estimating the specific pixel coordinates for each of the distant view images,
calculating, for each of the distant view images, an angle formed by a normal line of the object at the specific pixel coordinates and a line segment connecting the imaging position and the specific pixel coordinates, and
estimating the specific pixel coordinates based on a distant view image having the smallest angle among the plurality of distant view images.

### Supplementary Note 28

The program according to supplementary note 25, in which
the at least one distant view image includes a plurality of distant view images having different imaging positions/postures from each other, and
the coordinate estimation step includes estimating the specific pixel coordinates based on a distant view image having a largest ratio that is occupied by the close view image among the plurality of distant view images.

### Supplementary Note 29

The program according to supplementary note 25, in which the coordinate estimation step includes calculating a projection line emitted from the imaging position toward the at least one specific pixel based on the imaging position/posture, executing collision determination between the projection line and the object, and estimating the specific pixel coordinates based on the determination result.

### Supplementary Note 30

The program according to supplementary note 29, in which the coordinate estimation step includes extracting, from the point cloud, a partial point cloud whose distance to the projection line is equal to or less than a predetermined value, and estimating the specific pixel coordinates based on coordinates of a point closest to the imaging position in the partial point cloud.

### Supplementary Note 31

The program according to supplementary note 29, in which
the coordinate estimation step includes converting the point cloud into mesh data, and
executing a collision determination between the projection line and the object based on the mesh data.

### Supplementary Note 32

The program according to supplementary note 29, in which
the at least one specific pixel includes a plurality of specific pixels, and
the coordinate estimation step includes,
extracting, from the point cloud, a partial point cloud whose distance to the projection line is equal to or less than a predetermined value for each of the specific pixels,
clustering all the partial point clouds, and
estimating the specific pixel coordinates for each of the specific pixels based on any of a plurality of clusters obtained by the clustering.

### INDUSTRIAL APPLICABILITY

The present disclosure can be applied to a technique of estimating a positional relationship between a point cloud and a captured image having greatly different resolutions.

### REFERENCE SIGNS LIST

1 coordinate estimation device
2 bridge
3 close view image
3a close view image
4 distant view image
4a distant view image
5 abnormality
10 data accepting unit
11 point cloud storage unit
12 image storage unit
13 alignment unit
14 position/posture estimation unit
15 coordinate estimation unit
20 superimposed image generation unit
20a superimposed image
21 superimposed image output unit
22 history DB
23 history DB update unit
24 history DB extraction unit
25 history image output unit
C1 cluster
C2 cluster
H homography matrix
M line segment
L projection line
L1 projection line
L2 projection line
L3 projection line
Q specific pixel
Q1 specific pixel
Q2 specific pixel
Q3 specific pixel
R1 close view imaging region
R2 distant view imaging region
S normal line
T line segment
θ angle

What is claimed is:

1. A coordinate estimation system comprising:
at least one memory storing computer-executable instructions; and
at least one processor configured to access the at least one memory and execute the computer-executable instructions to:
align a close view image obtained by imaging a first imaging region of an object with at least one distant view image obtained by imaging a second imaging region that is larger than the first imaging region of the object and includes the first imaging region;
estimate an imaging position/posture including an imaging position and an imaging posture in a point cloud coordinate system of an image capturing apparatus that has captured the at least one distant view image based on a point cloud of the object and the at least one distant view image; and
estimate specific pixel coordinates in the point cloud coordinate system of at least one specific pixel that is an arbitrary pixel of the close view image based on the point cloud, an alignment result and the imaging position/posture.

2. The coordinate estimation system according to claim 1, wherein the at least one processor is further configured to calculate coordinates in the at least one distant view image of the at least one specific pixel based on the alignment result, and estimates the specific pixel coordinates based on the point cloud, the calculation result, and the imaging position/posture.

3. The coordinate estimation system according to claim 1, wherein
the at least one distant view image includes a plurality of distant view images having different imaging positions/postures from each other, and
the at least one processor is further configured to:
estimate the specific pixel coordinates for each of the distant view images,
calculate, for each of the distant view images, an angle formed by a normal line of the object at the specific pixel coordinates and a line segment connecting the imaging position and the specific pixel coordinates, and
estimate the specific pixel coordinates based on a distant view image having the smallest angle among the plurality of distant view images.

4. The coordinate estimation system according to claim 1, wherein
the at least one distant view image includes a plurality of distant view images having different imaging positions/postures from each other, and
the at least one processor is further configured to estimate the specific pixel coordinates based on a distant view image having a largest ratio that is occupied by the close view image among the plurality of distant view images.

5. The coordinate estimation system according to claim 1, wherein the at least one processor is further configured to calculate a projection line emitted from the imaging position toward the at least one specific pixel based on the imaging position/posture, execute collision determination between the projection line and the object, and estimate the specific pixel coordinates based on the determination result.

6. The coordinate estimation system according to claim 5, wherein the at least one processor is further configured to extract, from the point cloud, a partial point cloud whose distance to the projection line is equal to or less than a predetermined value, and estimate the specific pixel coordinates based on coordinates of a point closest to the imaging position in the partial point cloud.

7. The coordinate estimation system according to claim 5, wherein the at least one processor is further configured to
convert the point cloud into mesh data, and
execute a collision determination between the projection line and the object based on the mesh data.

8. The coordinate estimation system according to claim 5, wherein
the at least one specific pixel includes a plurality of specific pixels, and
the at least one processor is further configured to:
extract, from the point cloud, a partial point cloud whose distance to the projection line is equal to or less than a predetermined value for each of the specific pixels,
cluster all the partial point clouds, and
estimate the specific pixel coordinates for each of the specific pixels based on any of a plurality of clusters obtained by the clustering.

9. A coordinate estimation device comprising:
at least one memory storing computer-executable instructions; and
at least one processor configured to access the at least one memory and execute the computer-executable instructions to:
align a close view image obtained by imaging a first imaging region of an object with at least one distant view image obtained by imaging a second imaging region that is larger than the first imaging region of the object and includes the first imaging region;
estimate an imaging position/posture including an imaging position and an imaging posture in a point cloud coordinate system of an image capturing apparatus that has captured the at least one distant view image based on a point cloud of the object and the at least one distant view image; and
estimate specific pixel coordinates in the point cloud coordinate system of at least one specific pixel that is an arbitrary pixel of the close view image based on the point cloud, an alignment result and the imaging position/posture.

10. The coordinate estimation device according to claim 9, wherein the at least one processor is further configured to calculate coordinates in the at least one distant view image of the at least one specific pixel based on the alignment result, and estimates the specific pixel coordinates based on the point cloud, the calculation result, and the imaging position/posture.

11. The coordinate estimation device according to claim 9, wherein
the at least one distant view image includes a plurality of distant view images having different imaging positions/postures from each other, and
the at least one processor is further configured to:
estimate the specific pixel coordinates for each of the distant view images,
calculate, for each of the distant view images, an angle formed by a normal line of the object at the specific pixel coordinates and a line segment connecting the imaging position and the specific pixel coordinates, and
estimate the specific pixel coordinates based on a distant view image having the smallest angle among the plurality of distant view images.

12. The coordinate estimation device according to claim 9, wherein
the at least one distant view image includes a plurality of distant view images having different imaging positions/postures from each other, and
the at least one processor is further configured to estimate the specific pixel coordinates based on a distant view image having a largest ratio that is occupied by the close view image among the plurality of distant view images.

13. The coordinate estimation device according to claim 9, wherein the at least one processor is further configured to calculate a projection line emitted from the imaging position toward the at least one specific pixel based on the imaging position/posture, execute collision determination between the projection line and the object, and estimate the specific pixel coordinates based on the determination result.

14. The coordinate estimation device according to claim 13, wherein the at least one processor is further configured to extract, from the point cloud, a partial point cloud whose distance to the projection line is equal to or less than a predetermined value, and estimate the specific pixel coordinates based on coordinates of a point closest to the imaging position in the partial point cloud.

15. A coordinate estimation method being performed by a computer executing instructions stored in a memory, the coordinate estimation method comprising:
aligning a close view image obtained by imaging a first imaging region of an object with at least one distant view image obtained by imaging a second imaging region that is larger than the first imaging region of the object and includes the first imaging region;
estimating an imaging position/posture including an imaging position and an imaging posture in a point cloud coordinate system of an image capturing apparatus that has captured the at least one distant view image based on a point cloud of the object and the at least one distant view image; and
estimating specific pixel coordinates in the point cloud coordinate system of at least one specific pixel that is an arbitrary pixel of the close view image based on the point cloud, an alignment result of the aligning, and the imaging position/posture.

16. The coordinate estimation method according to claim 15, wherein the estimating of the coordinate includes calculating coordinates in the at least one distant view image of the at least one specific pixel based on the alignment result, and estimating the specific pixel coordinates based on the point cloud, the calculation result, and the imaging position/posture.

17. The coordinate estimation method according to claim 15, wherein
the at least one distant view image includes a plurality of distant view images having different imaging positions/postures from each other, and
the estimating of the coordinate includes,
estimating the specific pixel coordinates for each of the distant view images,
calculating, for each of the distant view images, an angle formed by a normal line of the object at the specific pixel coordinates and a line segment connecting the imaging position and the specific pixel coordinates, and
estimating the specific pixel coordinates based on a distant view image having the smallest angle among the plurality of distant view images.

18. The coordinate estimation method according to claim 15, wherein
the at least one distant view image includes a plurality of distant view images having different imaging positions/postures from each other, and
the estimating of the coordinate includes estimating the specific pixel coordinates based on a distant view image having a largest ratio that is occupied by the close view image among the plurality of distant view images.

19. The coordinate estimation method according to claim 15, wherein the estimating of the coordinate includes calculating a projection line emitted from the imaging position toward the at least one specific pixel based on the imaging position/posture, executing collision determination between the projection line and the object, and estimating the specific pixel coordinates based on the determination result.

20. The coordinate estimation method according to claim 19, wherein the estimating of the coordinate includes extracting, from the point cloud, a partial point cloud whose distance to the projection line is equal to or less than a predetermined value, and estimating the specific pixel coordinates based on coordinates of a point closest to the imaging position in the partial point cloud.
